(19) United States
(12) Patent Application Publication
(10) Pub. No.: US 2015/0022010 A1
(43) Pub. Date: Jan. 22, 2015

(54) WIRELESS CHARGING AND POWERING OF ELECTRONIC SENSORS IN A VEHICLE

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/946,128

(22) Filed: Jul. 19, 2013

(51) Int. Cl. B60R 16/03; H02J 7/02

(52) U.S. Cl. CPC B60R 16/03; H02J 7/025
USPC 307/104

(57) ABSTRACT

Configurations and methods of wireless power transmission for charging or powering one or more electronic sensors or devices within a vehicle are disclosed. Wireless power transmission for powering or charging one or more electronic sensors or devices within a vehicle may include a transmitter capable of emitting RF waves for the generation of pockets of energy; and one or more electronic sensors or electronic devices operatively coupled or otherwise embedded with one or more receivers that may utilize these pockets of energy for charging or powering. Such sensors or electronic devices may range from tire pressure gauges, security alarm sensors, rear window defrosters to audio speakers.

### CROSS-REFERENCES TO RELATED APPLICATIONS

The present disclosure is related to U.S. Non-Provisional patent application Ser. No. 13/891,430 filed May 10, 2013, entitled “Methodology For Pocket forming”; Ser. No. 13/925,469 filed Jun. 24, 2013, entitled “Methodology for Multiple Pocket-Forming”; and Ser. No. 13/946,082 filed Jul. 19, 2013, entitled “Method for 3 Dimensional Pocket-forming” the entire contents of Which are incorporated herein by these references.

### FIELD OF INVENTION

The present disclosure relates generally to wireless power transmission, and more particularly, to configurations and methods of wireless power transmission in vehicles.

### BACKGROUND OF THE INVENTION

Vehicles may utilize a variety of electrical wires for powering sensors, for example throttle position sensors, engine coolant temperature sensors, barometric sensors, as well as other electrical devices such as rear window defrosters, lighting, speakers and so on. The total amount of wires to be used gets rather large quickly. This may have both cost and environmental consequences. In addition, wires can easily short circuit or their connections can easily be loosened up thereby affecting the correct functionality of the sensors and electronic devices which depend on them for power. For the foregoing reasons, there may be a need for improved systems for power delivery in vehicles.

### SUMMARY OF THE INVENTION

Configurations and methods for wireless power transmission in vehicles' sensors are disclosed. Wireless power transmission for powering or charging one or more electronic devices inside a vehicle may include a transmitter capable of emitting RF waves for the generation of pockets of energy; and one or more electronic sensors operatively coupled with one or more receivers that may utilize these pockets of energy for charging or powering.

In an embodiment, a description of pocket-forming methodology using at least one transmitter and at least one receiver may be provided.

In another embodiment, a transmitter suitable for pocket-forming including at least two antenna elements may be provided.

In a further embodiment, a receiver suitable for pocket forming including at least one antenna element may be provided.

In an embodiment, a transmitter suitable for pocket-forming may provide wireless power to sensors located in the bottom part of a car.

In another embodiment, a transmitter suitable for pocket-forming may provide wireless power to sensors located in the engine compartment of a car. As a variant, the alarm system of the car may also be powered wirelessly.

In another embodiment, a transmitter suitable for pocket-forming may provide wireless power to interior devices such as rear window defroster and audio speakers.

The foregoing method and configurations for wireless power transmission in vehicles may reduce wire usage within cars. This may be beneficial from a stand-point of reducing cost, but also from an environmental perspective as less waste may be produced. In addition, sensors and gauges can improve their reliability as short-circuits may no longer be an issue.

### BRIEF DESCRIPTION OF THE DRAWINGS

Embodiments of the present disclosure are described by way of example with reference to the accompanying figures which are schematic and may not be drawn to scale. Unless indicated as representing the background information, the figures represent aspects of the present disclosure.

FIG. 1 illustrates wireless power transmission using pocket-forming, according to an embodiment.

FIG. 2 illustrates a component level illustration for a transmitter which may be utilized to provide wireless power transmission as described in FIG. 1, according to an embodiment.

FIG. 3 illustrates a component level embodiment for a receiver which can be used for powering or charging an electronic device as described in FIG. 1, according to an embodiment.

FIG. 4 illustrates a wireless power transmission where a transmitter may provide wireless power, through pocket-forming, to sensors in the bottom part of a car.

FIG. 5 illustrates a wireless power transmission where a transmitter may provide wireless power, through pocket-forming, to sensors in the engine compartment of a car.

FIG. 6 illustrates a wireless power transmission where a transmitter may provide wireless power, through pocket-forming, to sensors, gauges or small miscellaneous devices in the interior of a car such as a rear window defroster.

FIG. 7 illustrates a wireless power transmission where a transmitter may provide wireless power, through pocket-forming, to devices in the interior of car such as speakers from the audio system.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket forming to regulate power on one or more targeted receivers.

“Reflector” may refer to a device capable of efficiently reflecting the power of RF waves from a transmitter towards a receiver for the wireless charging of an electronic device.

### Description of the Drawings

In the following detailed description, reference is made to the accompanying drawings, which form a part hereof. In the drawings, which may not be to scale or to proportion, similar symbols typically identify similar components, unless context dictates otherwise. The illustrative embodiments described, in the detailed description, drawings and claims, are not meant to be limiting. Other embodiments can be used and/or and other changes can be made without departing from the spirit or scope of the present disclosure.

A. Essentials of Pocket-Forming

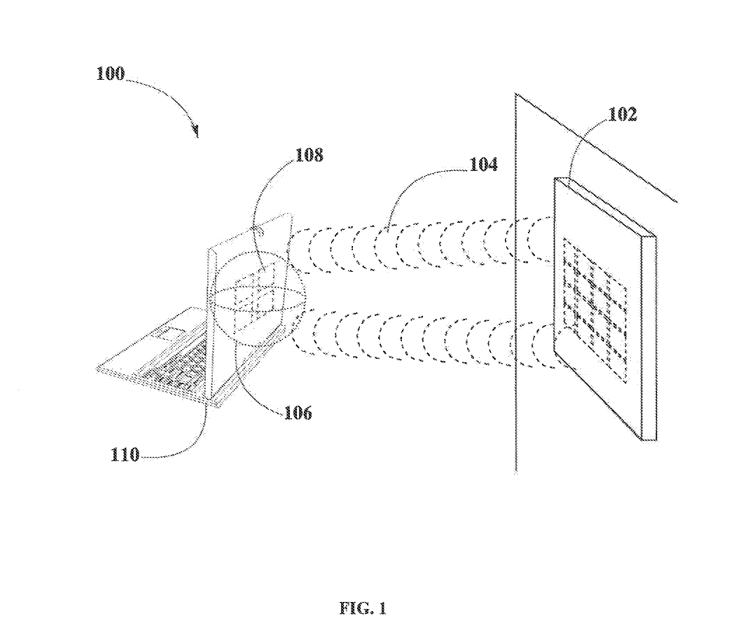

FIG. 1 illustrates wireless power transmission 100 using pocket-forming. A transmitter 102 may transmit controlled Radio Frequency (RF) waves 104 which may converge in 3-d space. These RF waves may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy 106 produced by pocket-forming for charging or powering an electronic device, for example a laptop computer 110 and thus effectively providing wireless power transmission. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

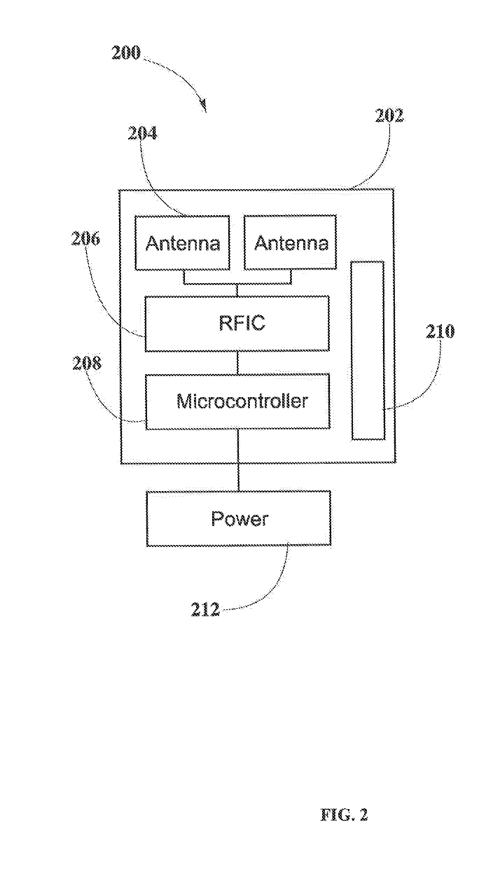

FIG. 2 illustrates a component level embodiment for a transmitter 200 which may be utilized to provide wireless power transmission 100 as described in FIG. 1. Transmitter 200 may include a housing 202 where at least two or more antenna elements 204, at least one RF integrated circuit (RFIC) 206, at least one digital signal processor (DSP) or micro-controller 208, and one optional communications component 210 may be included. Housing 202 can be made of any suitable material which may allow for signal or wave transmission and/or reception, for example plastic or hard rubber. Antenna elements 204 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ inch to about 6 inches and widths from about ⅛ inch to about 6 inches. Other antenna elements 204 types can be used, for example meta-materials, dipole antennas among others. RFIC 206 may include a proprietary chip for adjusting phases and/or relative magnitudes of RF signals which may serve as inputs for antenna elements 204 for controlling pocket-forming. These RF signals may be produced using an external power supply 212 and a local oscillator chip (not shown) using a suitable piezoelectric material. Micro-controller 208 may then process information send by a receiver through its own antenna elements for determining optimum times and locations for pocket-forming. In some embodiments, the foregoing may be achieved through communications component 210. Communications component 210 may be based on standard wireless communication protocols which may include Bluetooth, Wi-Fi or ZigBee. In addition, communications component 210 may be used to transfer other information such as an identifier for the device or user, battery level, location or other such information. Other communications component 210 may be possible which may include radar, infrared cameras or sound devices for sonic triangulation for determining the device's position.

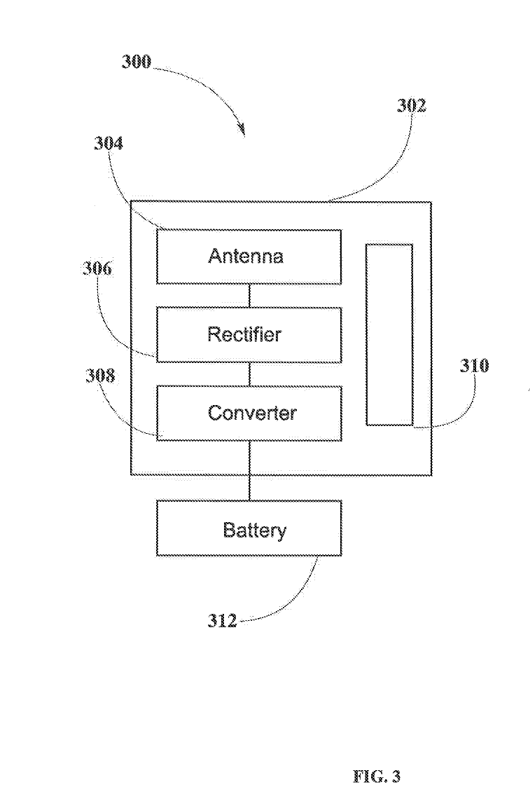

FIG. 3 illustrates a component level embodiment for a receiver 300 which can be used for powering or charging an electronic device as exemplified in wireless power transmission 100. Receiver 300 may include a housing 302 where at least one antenna element 304, one rectifier 306, one power converter 308 and an optional communications component 310 may be included. Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Antenna element 304 may include suitable antenna types for operating in frequency bands similar to the bands described for transmitter 200 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inch to about 6 inches and widths from about ⅛ inch to about 6 inches. Patch antennas may have the advantage that polarization may depend on connectivity, i.e. depending on which side the patch is fed, the polarization may change. This may further prove advantageous as a receiver, such as receiver 300, may dynamically modify its antenna polarization to optimize wireless power transmission. Rectifier 306 may include diodes or resistors, inductors or capacitors to rectify the alternating current (AC) voltage generated by antenna element 304 to direct current (DC) voltage. Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts. Lastly, communications component 310, similar to that of transmitter 200 from FIG. 2, may be included in receiver 300 to communicate with a transmitter or to other electronic equipment

B. Wireless Charging and Powering of Sensors in Vehicles

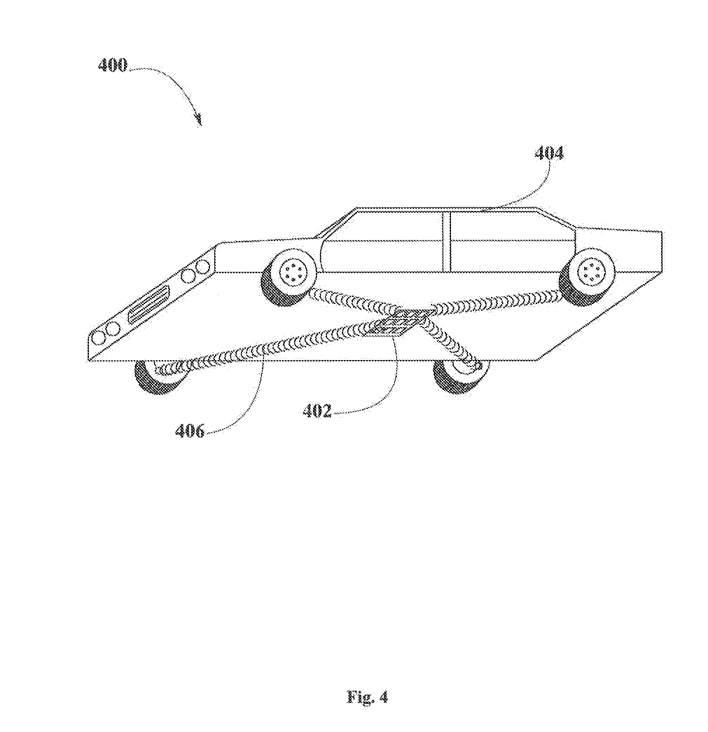

FIG. 4 illustrates a wireless power transmission 400 where a transmitter 402 may provide wireless power, through pocket-forming, to sensors in the bottom part of a car 404. Transmitter 402 can placed in the bottom of car 404, and may power, for example, tire pressure gauges, brake sensors and the like. The foregoing gauges and sensors may include embedded or otherwise operatively coupled receivers (not shown) for converting pockets of energy into usable energy. Even though the paths described by RF waves 406 in FIG. 1 appeared to be in straight lines, transmitter 402 can bounce RF waves 406 off of suitable reflecting areas of car 404 to improve power delivery efficiency. One of the main advantages of the foregoing disclosed configuration of wireless power transmission 400 may be the cost-effective solution of eliminating the wires required for powering the aforementioned sensors in the bottom of car 404.

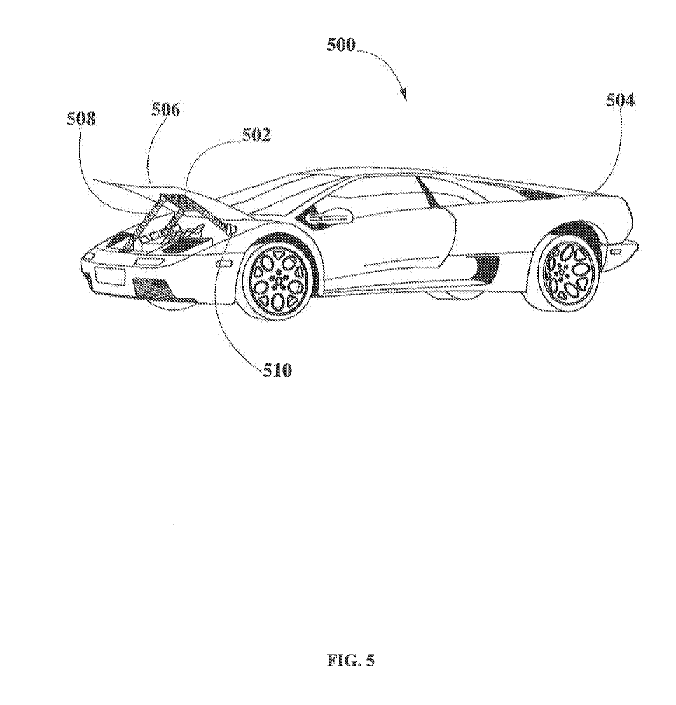

FIG. 5 illustrates a wireless power transmission 500 where a transmitter 502 may provide wireless power, through pocket-forming, to sensors in the engine compartment of a car 504. Transmitter 502 can be placed in the bottom internal surface of a hood 506 (or other suitable locations) from car 504 in order to power engine sensors such as throttle position sensors, engine coolant temperature sensors, barometric sensors and the like. As described in FIG. 1 above, transmitter 502 can use reflecting areas from the engine compartment of car 504 to bounce off RF waves 508 to improve power delivery efficiency. In some embodiments, transmitter 502 can be used to power the sensors present in typical alarm systems, for example, door sensors, pressure sensors for the interior of car 504), shock sensors and the like. In other embodiments, transmitter 502 can function as an alternate or main power supply for alarm speakers 510.

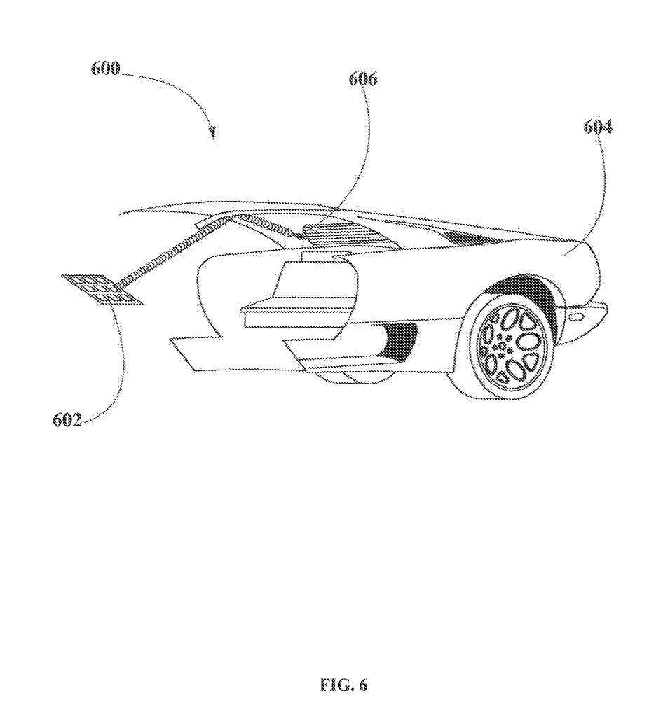

FIG. 6 illustrates a wireless power transmission 600 where a transmitter 602 may provide wireless power, through pocket-forming, to sensors, gauges or small miscellaneous devices in the interior of a car 604. In sonic embodiments, transmitter 602 can be placed in the instrument panel (not shown) of car 604. In this particular embodiment, transmitter 602 is shown to be powering a rear window defroster 606 from car 604, and thus diminishing the need for wires. In other embodiments, transmitter 602 can provide power to the actuators in the car windows, and even to the interior lighting system.

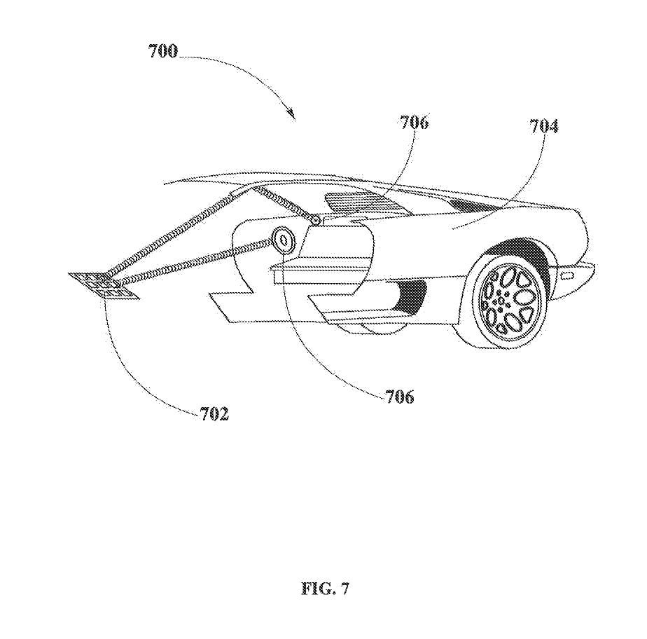

FIG. 7 illustrates a wireless power transmission 700 where a transmitter 702 may provide wireless power, through pocket-forming, to devices in the interior of car 704. In this embodiment, transmitter 702 can provide wireless power to speakers 706 while eliminating the usage of wires.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim.:

1. A method for wireless power transmission in a vehicle, comprising the steps of:
Emitting power RF waves from a transmitter generating pockets of energy through pocket-forming;
coupling receivers to vehicle sensors;
capturing the pockets of energy at the receivers; and
powering or charging the vehicle sensors from the captured pockets of energy.

2. The method for wireless power transmission in a vehicle of claim 1, wherein the pocket-forming transmitter is centrally located in a bottom portion of the vehicle to power tire pressure, brake sensors or other vehicle sensors located in a lower portion of the vehicle.

3. The method for wireless power transmission in a vehicle of claim 1, wherein the pocket-forming transmitter is located in an engine compartment of the vehicle to power engine sensors.

4. The method for wireless power transmission in a vehicle of claim 1, wherein the pocket-forming transmitter is located in an engine compartment of the vehicle to power engine sensors.

5. The method for wireless power transmission in a vehicle of claim 1, wherein the pocket-forming transmitter is located in an engine compartment of the vehicle to power an alarm system.

6. The method for wireless power transmission in a vehicle of claim 1, wherein the pocket-forming transmitter is located in a passenger compartment of the vehicle to power interior sensors and devices.

7. The method for wireless power transmission in a vehicle of claim 1, wherein the pocket-forming transmitter is located in a passenger compartment of the vehicle to power interior devices such as a rear window defroster and audio speakers.

8. The method for wireless power transmission in a vehicle of claim 1, further includes the step of reflecting pockets of energy off reflector surfaces of the vehicle toward a sensor receiver for the wireless charging or power of vehicle sensors and devices.

9. The method for wireless power transmission in a vehicle of claim 1, wherein the transmitter includes a microprocessor and at least two antenna elements for calculating values of phase and gain of the receiver to adjust transmitter antennas to form the pockets of energy used by the receiver in order to charge or power the vehicle sensors or devices.

10. The method for wireless power transmission in a vehicle of claim I, further comprising the step of communicating between the sensor receiver and the transmitter through short RF waves or pilot signals on conventional wireless communication protocols including Bluetooth, Wi-Fi, Zigbee or FM radio signals.

11. The method for wireless power transmission in a vehicle of claim 1, wherein the receiver includes circuitry configure to provide a constant DC voltage output in the range of approximately 5 to 10 volts.

12. A system for wireless power transmission in a vehicle, comprising:
a receiver connected to vehicle sensors or devices for charging or powering the vehicle sensors or devices;
a pocket-forming transmitter for emitting power RF waves to form pockets of energy to converge in 3-d space at the receiver for a power source.

13. The system for wireless power transmission in a vehicle of claim 12, wherein the pocket-forming transmitter is centrally located in a bottom portion of the vehicle to power tire pressure, brake sensors or other vehicle sensors located in a lower portion of the vehicle.

14. The system for wireless power transmission in a vehicle of claim 12, wherein the pocket-forming transmitter is located in an engine compartment of the vehicle to power engine sensors

15. The system for wireless power transmission in a vehicle of claim 12, wherein the pocket-forming transmitter is located in a passenger compartment of the vehicle to power interior sensors and devices.

16. The system for wireless power transmission in a vehicle of claim 12, wherein the pocket-forming transmitter is located in a passenger compartment of the vehicle to power interior devices such as a rear window defroster and audio speakers.

17. An apparatus for wireless power transmission in a vehicle, comprising:
a receiver connected to sensors and devices in the vehicle for supplying an operating voltage to the sensors and devices; and
a pocket-forming transmitter located within the vehicle for generating power RF waves to form pockets of energy for wirelessly transmitting power to the receiver.

18. The apparatus for wireless power transmission in a vehicle of claim 17, further including communication circuitry in the receiver and transmitter wherein the communication circuitry utilizes Bluetooth, infrared, Wi-Fi, FM radio or Zigbee for the communication protocols between the receiver and the transmitter,

19. The apparatus for wireless power transmission in a vehicle of claim 17, wherein the transmitter further includes flat antenna elements, patch antenna elements or dipole antenna elements with heights from approximately ⅛ inch to about 6 inches and widths from approximately ⅛ inch to about 6 inches. The apparatus for wireless power transmission in a vehicle of claim 19, wherein the antenna elements of the transmitter operate in frequency bands of 900 MHz, 2.5 GHz or 5.8 GHz.

20. The apparatus for wireless power transmission in a vehicle of claim 19, wherein the antenna elements of the transmitter operate in independent frequencies that allow a multichannel operation of pocket-forming in a single array, pair array, quad array or other suitable arrangement.

21. The apparatus for wireless power transmission in a vehicle of claim 19, wherein the antenna elements of the transmitter include polarization of vertical pole, horizontal, circularly polarized, left hand polarized, right hand polarized or a combination of polarizations.
